(19) United States
(12) Patent Application Publication
(10) Pub. No.: US 2006/0282437 A1
(43) Pub. Date: Dec. 14, 2006

(54) Apparatus, system, and method for ordered processing of a hierarchical data structure according to a data source

(76) Inventor: Gopalakrishnan Balasubramanian, Sunnyvale, CA (US)

Correspondence Address: KUNZLER & ASSOCIATES, 8 EAST BROADWAY, SUITE 600, SALT LAKE CITY, UT, 84111, US

(21) Appl. No.: 11/149,016

(22) Filed: Jun. 9, 2005

(51) Int. Cl. G06F 7/00

(52) U.S. Cl. 707/100

(57) ABSTRACT

An apparatus, system, and method are disclosed for ordered processing of a hierarchical data structure according to a hierarchy of a data source. The present invention comprises steps to reference a hierarchical data structure having nodes ordered within one or more hierarchical levels, traverse the hierarchical data structure according to an order defined in the hierarchical data structure, and process the nodes in each hierarchical level such that children of a parent node are processed before a subsequent sibling node of the parent node. Beneficially, such a system and method would allow for the processing of hierarchical data structures having two-way dependencies.

### BACKGROUND OF THE INVENTION

1. Field of the Invention

This invention relates to processing of data in information systems and more particularly relates to ordered processing of hierarchical data structures in information systems.

2. Description of the Related Art

Information systems often store attributes in complex data structures or hierarchies. These hierarchies may represent the relationships between the attributes, facilitate access or input of the attributes, or have some other purpose. As these hierarchies are processed, the system must determine an order for processing the attributes in the hierarchies.

Often, an attribute in a hierarchy is dependent on one or more other attributes in the hierarchy. For example, a structure may have a field for “fullname” that is created from a field for “lastname” and a field for “firstname”. In order for a repository to correctly process the dependent “fullname” field, it must first process the “lastname” and “firstname” fields. The system must have a policy for ordering the processing of attributes in order to consistently deal with these dependencies.

When a data structure is made up multiple hierarchical levels, ordering attributes for processing data becomes complicated. Present systems allow the option of processing hierarchical data structures in a top-down or bottom up approach. In a top-down approach, all of the attributes in the highest hierarchical level are processed before processing attributes in a level just below the highest hierarchical level. The attributes in the level below the highest hierarchical level are then processed before the next lower level, and so forth.

FIG. 1 illustrates a conventional way to order processing of a hierarchical data structure. Shown are a hierarchical data structure 102 having a first hierarchical level 104 and a second hierarchical level 106, and a processing order 108. The method 100 produces the processing order 108 (indicated by the arrow) based on the hierarchical data structure 102.

The hierarchical data structure 102 comprises attributes 110 organized into a hierarchy. The hierarchy may comprise one or more hierarchical levels, including a first hierarchical level 104 and a second hierarchical level 106. Attributes 110 are arranged within the hierarchical levels such that some attributes 110 are on the first hierarchical level 104 and some attributes 110 are on the second hierarchical level 106. Attributes 110 on the second hierarchical level 106 may descend from an attribute 110 on the first hierarchical level 104. Attributes 110 on the second hierarchical level 106 that descend from an attribute 110 on the first hierarchical level 104 are “children” (illustrated by “N1 . . . Nn”) of the connected, higher level attribute 110. The higher level attribute 110 is a “parent” (illustrated by “N1 . . . Nn”) or “complex” attribute 110 of the child attributes 110. Attributes 110 on the same hierarchical level descending from the same parent are “siblings.” Attributes 110 with no child attributes 110 are called “simple” or “leaf” attributes 110. Parent attributes 110 may comprise data or data objects, commands or command objects, objects, business objects, nodes, or the like. Child attributes 110 may also comprise data or data objects, commands or command objects, objects, business objects, nodes, or the like. Child attributes 110 may also be complex meaning a child attribute has children attributes 110 of its own.

Conventionally, the hierarchical data structure 102 is traversed by accessing the attributes 110 on the first hierarchical level 104 then accessing the attributes 110 on the second hierarchical level 106. The attributes 110 on the second hierarchical level 106 are not accessed/visited until all of the attributes 110 on the first hierarchical level 104 are accessed/visited. The resulting processing order 108 comprises the attributes 110 of the first hierarchical level 104 followed by the attributes 110 of the second hierarchical level 106. This type of ordering, where the attributes 110 of a first hierarchical level 104 are accessed before the attributes 110 of a lower, second hierarchical level 106 is referred to as “top-down” ordering.

In an alternative conventional ordering technique, the hierarchical data structure 104 may be traversed in a “bottom-up” method (not shown). In this method, the attributes 110 on the lower, second hierarchical level 106 are accessed before the attributes 110 on the higher, first hierarchical level 104. The resulting processing order (not shown) comprises the attributes 110 of the second hierarchical level 106 followed by the attributes 110 of the first hierarchical level 104.

The processing order 108 is the order that attributes 110 within the hierarchical data structure 102 will be processed. In many embodiments of hierarchical data structures 102, one or more attributes 110 within the hierarchical data structure 102 are dependent on one or more other attributes 110 within the hierarchical data structure 102. If a first attribute 110 is dependent upon a second attribute 110, the first attribute 110 cannot be correctly processed before the second attribute 110 is processed. For example, the first attribute 110 may be constructed from part of the second attribute 110. If the processing order 108 orders the first attribute 110 before the second attribute 110, the first attribute 110 will not be correctly processed.

If all of the dependencies in a hierarchical data structure 102 are of attributes 110 in the second hierarchical level 106 upon attributes 110 in the first hierarchical level 104, or of the attributes 110 in the first hierarchical level 104 upon attributes 110 in the second hierarchical level 106, the hierarchical data structure 102 has “one-way” dependencies. Selection of a top-down or bottom-up processing traversal allows proper processing of dependencies in a hierarchical data structure 102 that comprises only one-way dependencies. However, if the hierarchical data structure 102 includes both dependencies of attributes 110 in the second hierarchical level 106 upon attributes 110 in the first hierarchical level 104, and attributes 110 in the first hierarchical level 104 upon attributes in the second hierarchical level 106, the hierarchical data structure 102 has “two-way” dependencies. In a hierarchical data structure with two-way dependencies, neither a top-down nor a bottom-up technique will order the attributes 110 to correctly process the dependencies.

The top-down approach has the advantage of anticipating and properly processing attributes in lower hierarchical levels that depend upon attributes in higher hierarchical levels. However, the top-down approach fails to address dependencies of attributes in higher hierarchical levels upon attributes in lower hierarchical levels.

The bottom-up approach processes all of the attributes on the lowest hierarchical level before processing the attributes on the level immediately above the lowest hierarchical level, and so forth. The bottom-up approach correctly manages attributes in higher hierarchical levels that depend upon attributes in lower hierarchical levels, by processing the lower levels first. However, the bottom-up approach is not suitable when the data structure includes one or more attributes in lower hierarchical levels that are dependent upon an attribute in a higher hierarchical level.

Neither the top-down nor the bottom-up approach can correctly process a data structure that includes attributes dependent upon attributes in higher hierarchical levels and attributes dependent upon attributes in lower hierarchical levels. This two-way dependence cannot by properly processed by existing systems. When the relationships between the data that are represented by the attributes call for a data structure with two-way dependence, the data structure cannot be processed using conventional methods.

From the foregoing discussion, it should be apparent that a need exists for a system and method that orders the processing of hierarchical data structure according to a data source. Beneficially, such a system and method would allow for the processing of hierarchical data structures having two-way dependencies.

### SUMMARY OF THE INVENTION

The present invention has been developed in response to the present state of the art, and in particular, in response to the problems and needs in the art that have not yet been fully solved by currently available systems and methods for ordering processing of hierarchical data structures. Accordingly, the present invention has been developed to provide a system and method for ordered processing of a hierarchical data structure according to a data source that overcome many or all of the above-discussed shortcomings in the art.

A method of the present invention is presented for ordering processing of a hierarchical data structure according to a source data structure. In one embodiment, the method includes referencing an attribute order defined in a source data structure, determining an initial leaf node and a subsequent leaf node within a hierarchical data structure based on the attribute order, and processing the initial leaf node before processing the subsequent leaf node. The method also may include processing a parent node of the hierarchical data structure before processing siblings of the parent node that are ordered subsequent to the parent node in the attribute order.

In a further embodiment, the method includes processing hierarchical data structures comprising leaf nodes and parent nodes corresponding to attributes in the source data structure. In one embodiment, the hierarchical data structure has a node order that is different than the attribute order in the source data structure. In another embodiment, the node order of the hierarchical data structure corresponds to the attribute order in the source data structure. The method may include a sequence indicator that dictates the type of ordering method to be used.

A method for ordered processing of a hierarchical data structure according to a data source is also presented. The method, in one embodiment, includes referencing a hierarchical data structure having nodes ordered within one or more hierarchical levels. The nodes are traversed according to an order defined in the hierarchical data structure, and the nodes are processed within each hierarchical level such that children of a parent node are processed before a subsequent sibling node of the parent node. Processing of a node includes processing nodes within a next hierarchical level in response to one of the children also being a parent node.

In one embodiment, the hierarchical data structure comprises a command tree, and each leaf node of the hierarchical data structure comprises an Enterprise Information System (EIS) command. The method may process nodes by sending commands to an EIS in a way that satisfies the data constraints of the EIS. Each command may comprise one or more instructions to selectively create, retrieve, update, and delete attributes of a source data structure in an EIS.

The method may include a hierarchical data structure with one or more nodes dependent upon one or more nodes at higher hierarchical levels. The hierarchical data structure may also include one or more nodes dependent upon one or more nodes at lower hierarchical levels. A subsequent sibling of a parent node may be dependent upon a child of the parent node, and a child of a parent node may be dependent upon a preceding sibling of the parent node.

A system of the present invention is also presented for ordered processing of command in an Enterprise Information System (EIS). The system may be embodied by an EIS, an application server, and a Java Connector Architecture (JCA) adapter. In particular, the system, in one embodiment, includes a JCA comprising a command generator configured to generate a hierarchical command tree based on a hierarchical business object, a traverse module configured to traverse the hierarchical command tree to order commands of the command tree such that children of a parent command are ordered before a subsequent sibling command of the parent command, and an interpreter configured to receive the ordered commands from the traverse module and process each command.

The system may further include a hierarchical command tree corresponding to a hierarchy of a source data structure defined in the EIS. In another embodiment of the system, the order of the ordered commands corresponds to an attribute order of a source data structure defined in the EIS. The order of the ordered commands may also be different from an attribute order of a source data structure defined in the EIS.

In another embodiment, the system includes a sequence indicator configured to selectively control the traverse module, such that commands are either ordered such that children of a parent command are ordered before a subsequent sibling of the parent command, or in a conventional top-down or bottom-up approach.

In another embodiment, processing commands in the system includes sending EIS commands to an EIS such that the processing order of the command tree satisfies data constraints of the EIS. Each command may comprise one or more instructions to selectively create, retrieve, update, and delete attributes of a source data structure in the EIS.

The system may include a hierarchical command tree with one or more nodes dependent upon one or more nodes at higher hierarchical levels. The hierarchical command tree may also include one or more nodes dependent upon one or more nodes at lower hierarchical levels. A subsequent sibling of a parent node may be dependent upon a child of the parent node, and a child of a parent node may be dependent upon a preceding sibling of the parent node.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a conventional way to order processing of a hierarchical data structure;

FIG. 2 is a schematic block diagram illustrating one embodiment of an apparatus for ordered processing of a hierarchical data structure according to the present invention;

FIG. 3 is a schematic block diagram illustrating a source data structure, a corresponding hierarchical data structure, and a corresponding command tree according to one embodiment of the present invention;

FIG. 4 is a schematic block diagram illustrating one embodiment of a system for ordered processing of a hierarchical data structure according to one embodiment of the present invention; and

FIG. 5 is a schematic flow chart diagram illustrating one embodiment of a method for ordered processing of a hierarchical data structure in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The schematic flow chart diagrams included generally set forth as a logical flow chart diagram. The depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

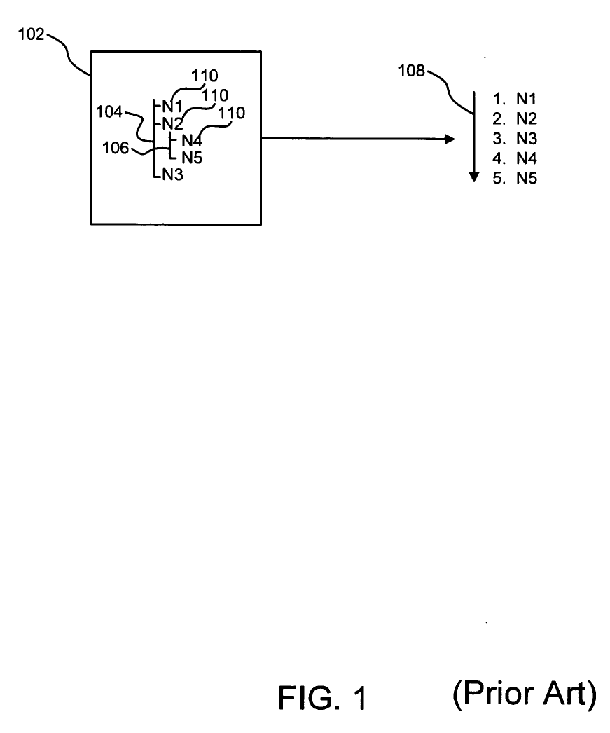

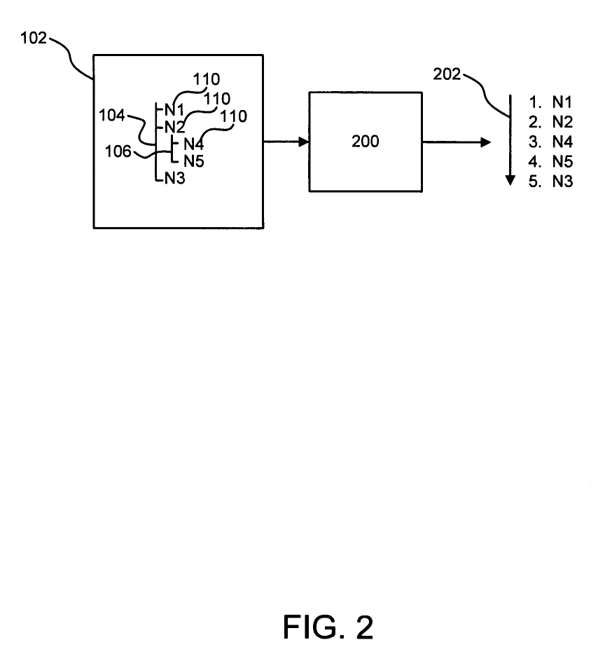

FIG. 2 illustrates an apparatus 200 for ordered processing of a hierarchical data structure 102 according to the present invention. The apparatus 200 operates on a hierarchical data structure 102 having a first hierarchical level 104 and a second hierarchical level 106 to produce a processing order 202. The hierarchical data structure 102, the first hierarchical level 104, and the second hierarchical level 106 are preferably configured in a manner similar to like numbered components described above in relation to FIG. 1. The apparatus 200 produces the processing order 202 based on the hierarchical data structure 102.

Suppose that hierarchical data structure 102 has a two-way dependency such that N4, a child of N2, is dependent on N1, and N3 is dependent on N5, a child of N2. As discussed above, the top-down technique will correctly order processing for N4, but will fail to correctly order processing for N3. Conversely, a bottom-up technique will fail to correctly order processing for N4, but will correctly order processing for N3.

Neither the top-down nor the bottom-up techniques for ordering processing of a hierarchical data structure 102 can correctly order processing in a hierarchical data structure 102 comprising two-way dependencies. However, the apparatus 200 is capable of handling two-way dependencies.

In the illustrated embodiment, the attributes 110 in the hierarchical data structure 102 have both an associated hierarchical level and an order (1, 2, 3, ... n) within that hierarchical level. Alternatively, the order may relate to the hierarchical data structure 102 as a whole instead of just within a hierarchical level. The order may be explicitly defined in the hierarchical data structure 102, or it may be implicitly defined by the order in which attributes 110 are defined in the hierarchical data structure 102. An example of an implicitly defined order is illustrated, wherein the definition order dictates the order (reading top to bottom and left to right). On the first hierarchical level 104, the attribute order is N1, N2, and N3. On the second hierarchical level 106, two attributes descend from N2 and are, in order, N4 and N5. Of course, other implicit order conventions may be applied to the hierarchical data structure 102 including right to left, bottom to top, and the like.

In one embodiment, the apparatus 200 traverses the hierarchical data structure 102 to develop a processing order 202 for the attributes in the hierarchical data structure. The apparatus 200 retrieves the attributes of the hierarchical data structure 102 in the order the attributes are defined in the hierarchical data structure 102, regardless of hierarchical level. This means that children of earlier parents (by order) are processed before children or parents later in the order of the hierarchical data structure 102.

The apparatus 200, in one embodiment, retrieves the first attribute 110 based on its order on the first hierarchical level 104. When the apparatus 200 retrieves an attribute 110 that is not a parent, it next retrieves the next sibling attribute 110 on the same hierarchical level. When the apparatus 200 retrieves a parent attribute, it next retrieves the first child of the parent attribute before retrieving a next ordered sibling attribute 110 of the parent attribute 110. The child attribute 110 may be a simple attribute 110 with no descending child attributes 110, or the child attribute 110 may be a complex attribute 110 with child attributes 110 descending to the next hierarchical level.

As will be appreciated by one skilled in the art, a variety of types and configurations of apparatus 200 may be utilized without departing from the scope and spirit of the present invention. For example, in one embodiment, the apparatus 200 traverses the hierarchical data structure 102 to develop a processing order 202 that is the reverse of the order that the attributes 110 are defined in the hierarchical data structure 102. In this embodiment, the apparatus 200 retrieves the last attribute 110 on a hierarchical level first, and proceeds by selecting previous attributes 110 rather than next attributes. In another embodiment, the apparatus 200 determines dependencies between attributes 110 and develops a processing order 202 in response to those dependencies that will allow dependent attributes 110 to be correctly processed. The apparatus 200 may then add to the processing order 202 attributes 110 without dependencies.

In one embodiment, the processing order 202 is developed in response to the hierarchical data structure 102 by the ordering apparatus 200 and comprises the order that attributes 110 within the hierarchical data structure 102 will be processed. In one embodiment of a hierarchical data structure 102 having two-way dependencies, N4, a child of N2, is dependent on N1, and N3 is dependent on N5, a child of N2. Such two-way dependencies cannot be correctly processed by a top-down or a bottom-up ordering method. The ordering apparatus 200 of the illustrated embodiment, however, correctly produces a processing order 202 that places N1 before N4 and N5 before N3, thus allowing correct processing of the two-way dependencies.

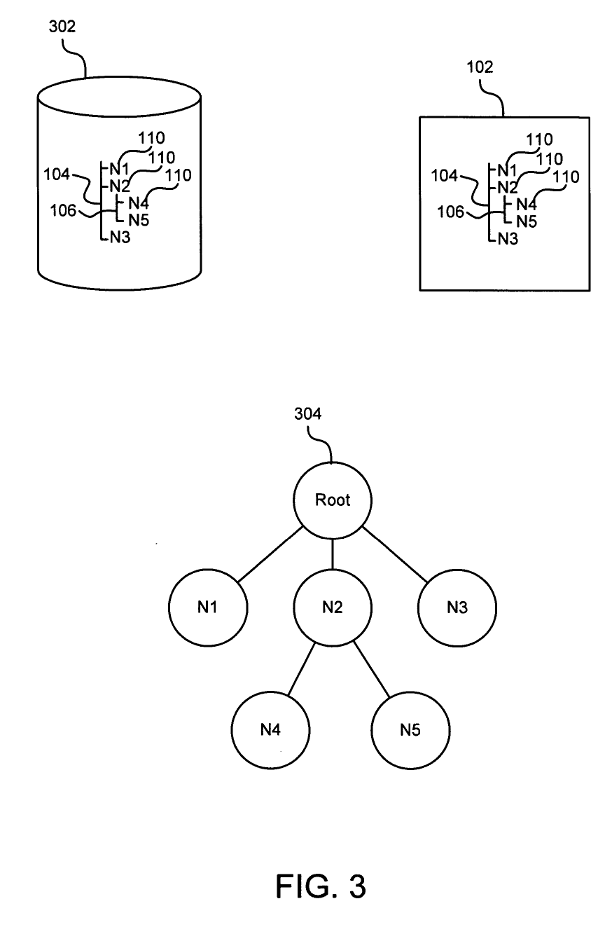

FIG. 3 illustrates one embodiment of a source data structure 302, a hierarchical data structure 102, and a command tree 304. The hierarchical data structure 102 corresponds to the source data structure 302, and the command tree 304 corresponds to the hierarchal data structure 102. This means that the nodes or attributes 110 of the different structures 102, 302, 304 match and that the hierarchical structure is the same between the structures 102, 302, 304.

In one embodiment, the source data structure 302 comprises hierarchically arranged attributes 110. The hierarchy may be explicit in the structure of the source data structure 302 using for example pointers. The source data structure 302 may be referenced in order to define the attributes 110 and structure of the hierarchical data structure 102. In another embodiment, the source data structure 302 may comprise one or more tables of attributes 110 organized in a relational database. Alternatively, the source data structure 302 may comprise a hierarchical record in a hierarchical database. Examples of source data structures 302 are data structures within Enterprise Information Systems (EIS) such as PeopleSoft™, Oracle™, SAP™, and the like.

The hierarchal data structure 102, in one embodiment, comprises attributes 110 and hierarchical levels that correspond to attributes 110 and hierarchical levels in the source data structure 302. The hierarchical data structure 102 may be an isomorph (meaning that the attributes and structure match between the two structures) of the source data structure 302, having attributes 110 and hierarchical levels that map directly to the attributes 110 and hierarchical levels in the source data structure 302. Examples of hierarchical data structures 102 include application-specific business objects in WebSphere™ application servers, generic business objects, and the like. Alternatively, the hierarchal data structure 102 is a subtree of a source data structure 302.

As will be appreciated by one skilled in the art, a variety of types and configurations of hierarchical data structures 102 may be utilized without departing from the scope and spirit of the present invention. For example, in one embodiment, the hierarchical data structure 102 may be an isomorph of a portion of the source data structure 302. In another embodiment, the hierarchical data structure 102 may be a translation of the source data structure 302. In yet another embodiment, the hierarchical data structure 102 may correspond to more than one source data structure 302. In another embodiment, the hierarchical data structure 102 may have an attribute order different from the attribute order in the source data structure 302.

In one embodiment, the command tree 304 comprises nodes including a root, and nodes on one or more hierarchical levels. The nodes of the command tree 304 may correspond to attributes of the hierarchical data structure 102. In one embodiment, the command tree 304 is an isomorph of the hierarchical data structure 102. In certain embodiments, the command tree 304 represents a set of commands that are to be issued to an EIS in order to create, delete, or modify the source data structure 302. The command tree 304 may comprise a subset of the hierarchical data structure 102. For example, certain attributes 110 may have no associated command and hence no node in the command tree 304. Alternatively, the command tree 304 may include a node for each attribute 110. Command nodes for attributes 110 that are unchanged may have a no-op command.

The root may be a parent node, and the nodes on the first hierarchical level below the root descend from the root node. Nodes may be parent nodes or leaf nodes. Leaf nodes, in one embodiment, comprise commands to selectively create, retrieve, update, and delete corresponding attributes 110 in the source data structure 302. Parent nodes may include no commands but have one or more child nodes at a lower hierarchical level. The child nodes may also be parent nodes or leaf nodes as described above.

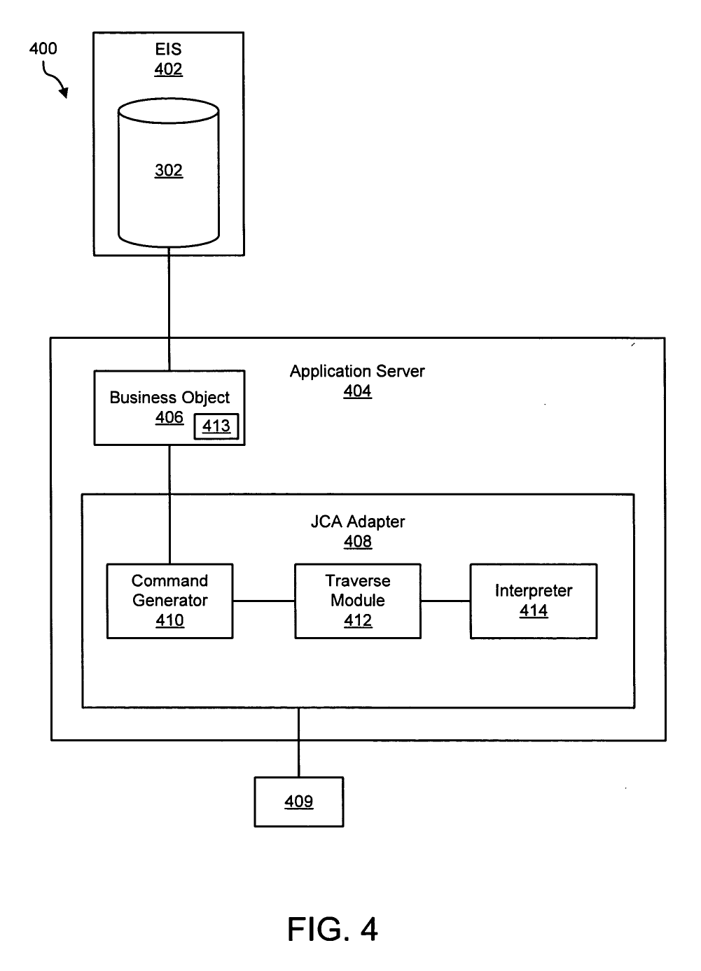

FIG. 4 illustrates one embodiment of a system for ordered processing 400 of a hierarchical data structure of the present invention. The system 400 comprises an EIS 402, an application server 404, a business object 406, and a Java Connector Architecture (JCA) adapter 408.

The EIS 402 provides information and structure for a source data structure 302 that can be processed by an application server 404. In one embodiment, the EIS 402 comprises a source data structure 302 containing attributes. The attributes in the EIS 402 may be organized into hierarchies. Examples of EIS's 402 include PeopleSoft™, Oracle™, SAP™, legacy servers, and the like.

The application server 404 acts on attributes stored in a business object 406 through a JCA adapter 408. The application server 404 provides the data communication, security, integrity, and execution environment for operating with business objects 406. The application server 404 is in communication with the EIS 402. Preferably, the application server 404 also communicates with a plurality of clients (not shown). In certain systems 400, the application server 404 serves as an integration broker for a plurality of other client applications. Examples of application servers 404 include Java 2 Platform, Enterprise Edition™ (J2EE) servers, IBM WebSphere,™ and the like.

The business object 406 is a set of data that represents a business entity or other business application structure. The business object 406 may also include certain methods for operating on the included data. Typically, the data is stored in structures of the business object known as attributes.

In one embodiment, the business object 406 comprises a hierarchical data structure. The business object 406 is in communication with the EIS 402 and the hierarchical data structure of the business object 406 may correspond to the source data structure 302 of the EIS 402. In one embodiment, the hierarchical data structure of the business object 406 is an isomorph of the source data structure of the EIS 402.

As will be appreciated by one skilled in the art, a variety of types and configurations of business objects 406 may be utilized without departing from the scope and spirit of the present invention. For example, in one embodiment, the business object 402 may be an isomorph of a portion of the source data structure in the EIS 402. In another embodiment, the business object 402 may be a translation or mapping of the source data structure 302 in the EIS 402. In yet another embodiment, the business object 402 may correspond to source data structures in more than one EIS 402.

The JCA adapter 408 is configured to exchange data between the EIS 402 and one or more client applications 409. The JCA adapter 408 enables the client applications 409 as well as components of the application server 404 to effectively interact with the EIS 402. The client applications 409 and components use published interface calls and commands to interact with the EIS 402. The JCA adapter 408 converts these interface calls into native calls understood by the respective EIS 402. The JCA adapter 408 may comprise a command generator 410, a traverse module 412, and an interpreter 414.

In one embodiment, the command generator 410 generates a hierarchical command tree 304 corresponding to the hierarchy of the business object 406. The generated command tree 304 comprises commands to selectively create, retrieve, update, and delete attributes source data structure 302 of the EIS 402.

The traverse module 412 traverses the command tree 304 generated by the command generator 410 to produce ordered commands. In one embodiment, the traverse module 412 orders commands such that children of a parent command are ordered before a subsequent sibling command of the parent command. In certain embodiments, the traverse module 412 includes the apparatus 200 discussed above. In another embodiment, the traverse module 412 may order commands such that children commands of a parent command are ordered after a subsequent sibling of the parent command.

In another embodiment, the traverse module 412 may receive a sequence indicator 413 from the application server 404. In the illustrated embodiment, the sequence indicator 413 is included within the business object 406. The sequence indicator 413 indicates the type of traversal to be applied to the command tree 304. For example, the sequence indicator 413 may indicate that the command tree 304 should be ordered in the order the attributes are defined in the business object 406 with child commands of a parent command ordered before subsequent sibling commands of the parent command (referred to herein as ordered traversal).

In the alternative, the sequence indicator 413 may indicate that a top-down approach be applied to the business object 406. The sequence indicator 413 may indicate traversal types selected from the group comprising ordered traversal, top-down traversal, and bottom-up traversal. In this manner, the setting of the sequence indicator 413 either programmatically or through a configuration setting can control the traversal order for the application server 404.

The interpreter 414, in one embodiment, receives the ordered commands from the traverse module 412 and processes the commands. The interpreter 414 determines what command to execute by analyzing the command. The interpreter 414 may then generate the native command for the EIS 402 in order to execute the command. The interpreter 414 may then send the native commands to the EIS 402 for execution.

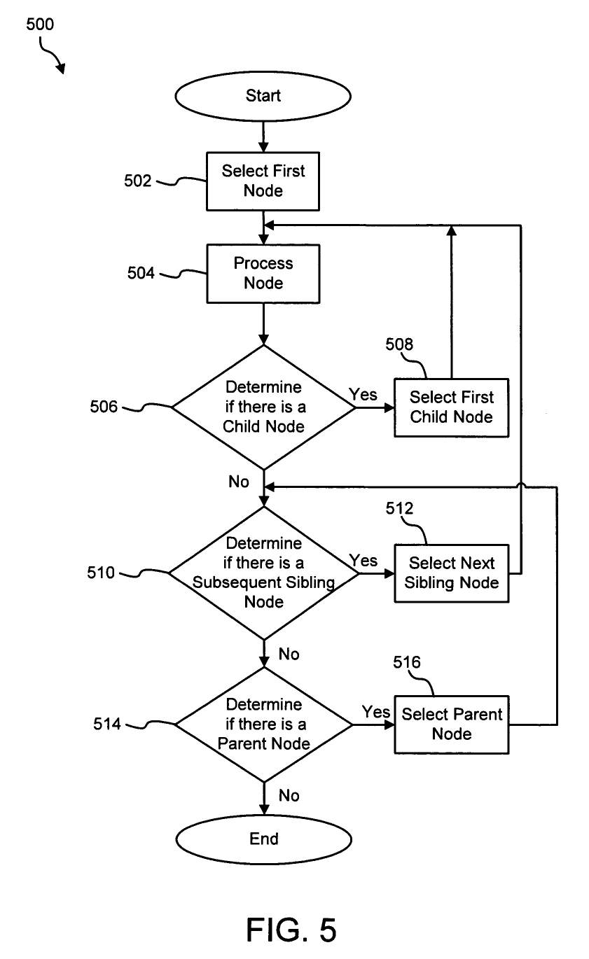

FIG. 5 illustrates a flow chart for one embodiment of a method 500 for ordered processing of a hierarchical data structure according to the present invention. Initially, the method 500 selects 502 a first node. The node may be a root node in a command tree 304. In another embodiment, the node may be a first attribute 110 on a first hierarchical level in a hierarchical data structure 102. The first node is referred to with respect to FIG. 5 as “the selected node” as the method 500 continues.

Next, the apparatus 200 processes 504 the selected node. Processing 504 the selected node may comprise placing the command associated with the selected node next in an order produced by the method 500. The command associated with the selected node may be an instruction to selectively create, retrieve, update, and delete attributes in a source data structure. Processing 504 the selected node may comprise simply traversing to, or visiting the node, especially if the node has children. Processing 504 the selected node may also comprise advancing within the command tree 304 to a child node if the currently selected node has child nodes.

Next, a determination module of the apparatus 200 determines 506 if the selected node has a child node. A child node may comprise a separate command in the command tree 304 on a lower hierarchical level descending from the selected node. The child node may be a simple node, having no child nodes, or it may be a parent node having one or more child nodes of its own.

If the selected node has a child node, a selection module of the apparatus 200 selects 508 the first child node of the node. The first child node is a child node ordered first among nodes descended from the same parent on the same hierarchical level. The first child node then becomes “the selected node” and the method 500 returns to process 504 the selected node.

If the selected node in step 506 does not have a child node, the determination module of the apparatus 200 determines 510 if the selected node has a subsequent sibling node. A subsequent sibling node is a node in the command tree that is descended from the same parent as the selected node, is on the same hierarchical level as the selected node, and is ordered later within the hierarchical level than the selected node.

If the selected node has a subsequent sibling node, the selection module of the apparatus 200 selects 512 the next sibling node. The next sibling node is the node descending from the same parent as the selected node, on the same hierarchical level as the selected node, and ordered immediately after the selected node. The next sibling node becomes “the selected node” and the method 500 returns to process 504 the selected node.

If the selected node does not have a subsequent sibling node, the determination module of the apparatus 200 determines 514 if the selected node has a parent node. A parent node is a node from which the selected node descends.

If the selected node has a parent node, the selection module of the apparatus 200 selects 516 the parent node. The parent node becomes “the selected node” and the method 500 returns to determine 510 if the selected node has a subsequent sibling node.

A node that does not have a parent node is a first node or root. When the method 500 returns to the first node or root, all of the nodes in the command tree have been processed, and the commands have been ordered according to the method 500. The method 500 ends.

As will be appreciated by one skilled in the art, a variety of types and configurations of methods 500 for ordered processing of a hierarchical data structure 102 may be utilized without departing from the scope and spirit of the present invention. For example, in one embodiment, the method 500 may order the processing of a hierarchical data structure 102 such that commands are processed in the opposite order than they are defined in the command tree 304.

Initially, the method 500 selects 502 a first node. The node may be a root node in a command tree. In another embodiment, the node may be a last attribute on a first hierarchical level in a hierarchical data structure. The first node becomes “the selected node” as the method 500 continues.

Next, the method 500 processes 504 the node. Processing 504 the node may comprise placing the command associated with the node next in the order determined by the method 500. The command associated with the node may be an instruction to selectively create, retrieve, update, and delete attributes in a source data structure.

Next, the method 500 determines 506 if the node has a child node. A child node may comprise a separate command in the command tree on a lower hierarchical level descending from the node.

If the node has a child node, the method 500 selects (not shown) the last child node of the node. The last child node is the child node ordered last among nodes descended from the same parent on the same hierarchical level. The last child node becomes “the selected node” and the method 500 returns to the process 504 the node step.

If the node does not have a child node, the method 500 determines (not shown) if the node has a previous sibling node. A previous sibling node is a node in the command tree that is descended from the same parent as the node, is on the same hierarchical level as the node, and is ordered earlier within the hierarchical level than the node.

If the node has a previous sibling node, the method 500 selects (not shown) the preceding sibling node. The preceding sibling node is the node descending from the same parent as the node, on the same hierarchical level as the node, and ordered immediately before the node. The preceding sibling node becomes “the selected node” and the method 500 returns to the process 504 the node step.

If the node does not have a previous sibling node, the method 500 determines 514 if the node has a parent node. A parent node is a node from which the node descends.

If the node has a parent node, the method 500 selects 516 the parent node. The parent node becomes “the selected node” and the method 500 returns to the determine (not shown) if the node has a previous sibling node step.

A node that does not have a parent node is a first node or root. When the method 500 returns to the first node or root, all of the nodes in the command tree have been processed, and the commands have been ordered according to the method 500. The method 500 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code for ordering processing of a hierarchical data structure according to a source data structure, the computer program product including:
computer usable program code for referencing an attribute order defined in a source data structure;
computer usable program code for determining an initial leaf node and a subsequent leaf node within a hierarchical data structure based on the attribute order; and
computer usable program code for processing the initial leaf node before processing the subsequent leaf node.

2. The computer program product of claim 1, wherein the computer usable program code further comprises processing a parent node of the hierarchical data structure before processing siblings of the parent node that are ordered subsequent to the parent node in the attribute order.

3. The computer program product of claim 1, wherein the hierarchical data structure comprises leaf nodes and parent nodes corresponding to attributes in the source data structure.

4. The computer program product of claim 1, wherein the order of nodes in the hierarchical data structure is independent of the attribute order in the source data structure.

5. The computer program product of claim 1, wherein the computer usable program code for determining an initial leaf node further comprises reading a sequence indicator configured to order node processing selectively based on the attribute order and a hierarchy of the hierarchical data structure.

6. A method for ordered processing of a hierarchical data structure according to a data source, the method comprising:
referencing a hierarchical data structure having nodes ordered within one or more hierarchical levels;
traversing the hierarchical data structure according to an order defined in the hierarchical data structure;
processing nodes within each hierarchical level such that children of a parent node are processed before a subsequent sibling node of the parent node; and
wherein processing comprises processing nodes within a next hierarchical level in response to one of the children also being a parent node.

7. The method of claim 6, wherein the hierarchical levels within the hierarchical data structure correspond to a hierarchy defined in a source data structure.

8. The method of claim 6, wherein a node order in the hierarchical data structure corresponds to an attribute order in a source data structure.

9. The method of claim 6, wherein processing nodes further comprises reading a sequence indicator configured to selectively process children of parent nodes prior to processing subsequent nodes within a hierarchical level and process subsequent leaf nodes prior to processing the children of parent nodes on the same hierarchical level.

10. The method of claim 6, wherein the hierarchical data structure comprises a command tree configured such that each leaf node of the command tree comprises an Enterprise Information System (EIS) command.

11. The method of claim 10, wherein processing nodes comprises sending EIS commands to an EIS such that the processing order of the command tree satisfies data constraints of the EIS.

12. The method of claim 10 wherein each command comprises one or more instructions to selectively create, retrieve, update, and delete attributes of a source data structure of the EIS.

13. The method of claim 6, wherein a subsequent sibling of a parent node is dependent upon a child node of the parent node.

14. A system for ordered processing of commands in an Enterprise Information System (EIS), the system comprising:
an EIS;
an application server in communication with the EIS; and
a Java Connector Architecture (JCA) adapter operating on the application server, the JCA adapter comprising:
a command generator configured to generate a hierarchical command tree based on a hierarchical business object;
a traverse module configured to traverse the hierarchical command tree to order commands of the command tree such that children of a parent command are ordered before a subsequent sibling command of the parent command; and
an interpreter configured to receive the ordered commands from the traverse module and process each command.

15. The system of claim 14, wherein the hierarchical command tree corresponds to a hierarchy of a source data structure defined in the EIS.

16. The system of claim 14, wherein the order of the ordered commands corresponds to an attribute order of a source data structure defined in the EIS.

17. The system of claim 14, wherein the traverse module reads a sequence indicator configured to selectively:
order commands such that children of a parent command are ordered before a subsequent sibling command of the parent command; and
order commands such that a subsequent sibling command of a parent command is processed before children of a parent command.

18. The system of claim 14, wherein processing commands comprises sending EIS commands to an EIS such that the processing order of the command tree satisfies data constraints of the EIS.

19. The system of claim 14, wherein each command comprises one or more instructions to selectively create, retrieve, update, and delete attributes of a source data structure of the EIS.

20. The system of claim 14, wherein a data value for a child of a parent command depends on a data value of a preceding sibling of the parent command.
